(19) United States
(12) Patent Application Publication
(10) Pub. No.: US 2008/0072837 A1
(43) Pub. Date: Mar. 27, 2008

(54) FOLDABLE PET CAGE

(75) Inventors: Andrezj M. Redzisz, Wheeling, IL (US); Brad L. Schantz, Evanston, IL (US); Du Hai, Quan Zhou (CN)

Correspondence Address: BANNER & WITCOFF, LTD., TEN SOUTH WACKER DRIVE, SUITE 3000, CHICAGO, IL, 60606, US

(73) Assignee: Travel Caddy, Inc. d/b/a Travelon, Elk Grove Village, IL (US)

(21) Appl. No.: 11/559,499

(22) Filed: Nov. 14, 2006

Related U.S. Application Data
(60) Provisional application No. 60/841,445, filed on Aug. 31, 2006.

(51) Int. Cl. A01K 1/03

(52) U.S. Cl. 119/474; 119/498

(57) ABSTRACT

A foldable pet cage is comprised of six four-sided panels fabricated from generally flexible material with selected panels reinforced with stiffening elements positioned at strategic locations so as to enable folding of the six panels over one another into an array which is compact.

### CROSS REFERENCE TO RELATED APPLICATION

This application is the utility application of provisional application Ser. No. 60/841,445 filed Aug. 31, 2006 entitled “Foldable Pet Cage” for which priority is claimed.

### BACKGROUND OF THE INVENTION

In a principal aspect the present invention relates to a soft or fabric sided cage or enclosure, especially useful for housing or carrying pets, which may be folded into a compact configuration for storage, shipping or the like when not in use.

Pets, especially small pets, often accompany their owners on travels. With respect to such an event, it may be desirable to have a cage for the pet in order to maintain control of the pet while at the same time providing protection for the pet. On the other hand, movement and transport of a bulky cage when the cage is not in use can be considered unpleasant or undesirable inasmuch as the cumbersome and bulky cage may be difficult to transport, particularly when empty and may well intrude upon available space. Thus, a need developed for a pet cage or enclosure which may be unfolded for use and habitation by the pet or alternatively folded into a slim and unobtrusive package. Additionally, for purposes of display by a merchandiser, it may be desirable to have the cage or enclosure fully opened, whereas for purposes of shipment, storage and the like it may be desirable to have the item in a folded condition.

Thus, there has developed a need for a foldable pet cage which is rugged yet utilitarian and which may be folded into a compact case for ease of storage, transport or the like.

### SUMMARY OF THE INVENTION

Briefly, the present invention comprises a foldable pet cage which includes six, four-sided panels interconnected or interconnectable to define an enclosure. The panels are constructed of generally flexible material, and selected panels are reinforced with strategically located stiffening elements. Thus, the cage includes first and second generally congruently shaped end panels fabricated from a flexible material. The end panels each include a generally peripheral stiffening element. The end panels are connected to a bottom panel which, in a preferred embodiment, includes a stiffening element. The end panels are also connected to one another by a front panel of flexible fabric and a back panel which incorporates a stiffening element. The back panel is joined to a top flap or panel. The top flap and back panel are removably attached around the periphery thereof to the end panels and the front panel. In a preferred embodiment the attachment is effected by a zipper mechanism.

The top panel and back panel may be detached from the front and side or end panels. The end panels and front panel may then be folded over the bottom panel. Subsequently, the back panel and top panel may be folded over the previously folded end panels, front panel and bottom panel. Various fasteners may be utilized to hold the assembly of folded panels in the folded condition.

The end panels preferably are fabricated at least partially from a mesh fabric as is the front panel for purposes of ventilation and access to light when the enclosure is in the assembled condition. Handles are attached to the front and back panels. The end panels may include sub-panels that may be detached for access to the interior of the enclosure.

Therefore, the panels, which are typically constructed from a flexible fabric material, may be folded into a compact array wherein the panels are all made to overlie one another or unfolded to form a six-sided enclosure.

Thus, it is an object of the invention to provide an improved collapsible pet cage construction.

A further object of the invention is to provide a pet cage construction which includes six panels, each panel having four sides wherein the panels are connected, or may be connected, to one another to form an enclosure of generally flexible fabric material including mesh fabric to provide for ventilation and light.

Another object of the invention is to provide a pet cage which is fabricated from generally flexible material such as fabric and which is rugged, inexpensive and highly portable.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of an embodiment of the foldable pet cage of the invention depicting the manner in which a pet may be placed therein;

FIG. 2 is an isometric view of the embodiment of FIG. 1 wherein the end panel of the enclosure is open for access to the enclosure or pet cage;

FIG. 3 is an isometric view of the embodiment of FIG. 1 as depicted from the back side thereof;

FIG. 4 is an isometric view of the embodiment of FIG. 1 having an open top panel and as viewed from the front panel;

FIG. 5 is an isometric view from the opposite side of FIG. 4;

FIG. 6 is an isometric view depicting the manner in which the back panel and top panel of the pet cage or enclosure of FIG. 1 may be opened;

FIG. 7 is a further isometric depiction of the opening of the pet cage or embodiment of FIG. 1;

FIG. 8 further depicts the construction of FIG. 7 in an isometric view;

FIG. 9 is an isometric view of the construction of FIG. 8 depicting the reinforcing elements utilized therein;

FIG. 10 further illustrates the reinforcing elements of FIG. 9 in an isometric view;

FIG. 11 is an isometric view illustrating the manner in which the back panel may include an auxiliary reinforcing panel incorporated which is foldable between a position against the bottom panel and a position against the back side panel;

FIG. 12 illustrates the auxiliary bottom panel and the reinforcing element associated therewith in an isometric view;

FIG. 13 is another isometric view of the construction of FIG. 12;

FIG. 14 is an isometric view of the construction of FIG. 12;

FIG. 15 is a further isometric view of the construction of FIG. 12;

FIG. 16 is an isometric view of the construction of FIG. 12 illustrating the construction of the end panels as well as the back panel and bottom panels;

FIG. 17 is an isometric view of an end panel;

FIG. 18 is a partially cutaway isometric view of the end panel of FIG. 17;

FIG. 19 is a further cutaway isometric view of the end panel of FIG. 17;

FIG. 20 is an isometric view of the peripheral reinforcing element associated with the end panel of FIG. 17;

FIG. 21 is an isometric view illustrating the manner of folding of the end panels and front panel over the bottom panel for the embodiment of the invention;

FIG. 22 is a further isometric view illustrating folding of the pet cage construction;

FIG. 23 is an isometric view illustrating the folded end panels and bottom panel and front panel folded into a compact array;

FIG. 24 is an isometric view illustrating the manner of folding the back side panel and top side panel over the folded array of FIG. 23;

FIG. 25 is a further isometric view illustrating the folding of the pet cage construction;

FIG. 26 illustrates in an isometric view the arrangement for retaining the folded pet cage construction in the folded condition;

FIG. 27 is a further isometric view illustrating the manner in which the folded pet construction is maintained in its folded condition;

FIG. 28 illustrates the folded pet cage construction wherein a fastening mechanism for maintaining the pet cage construction in the folded condition is fully engaged; and

FIG. 29 is an opposite side view in an isometric view of the folded construction of FIG. 28.

### DESCRIPTION OF THE PREFERRED EMBODIMENT

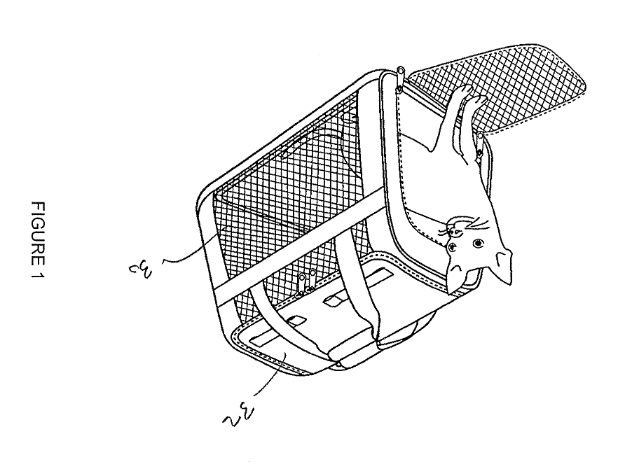

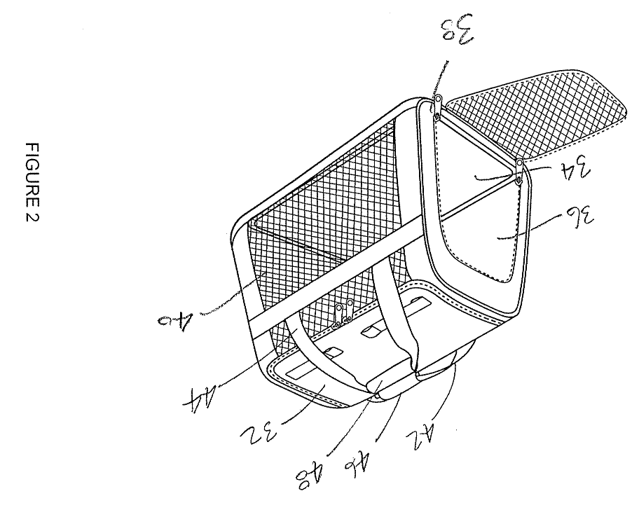

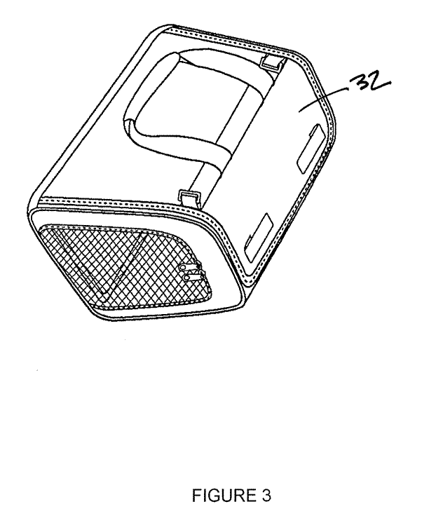

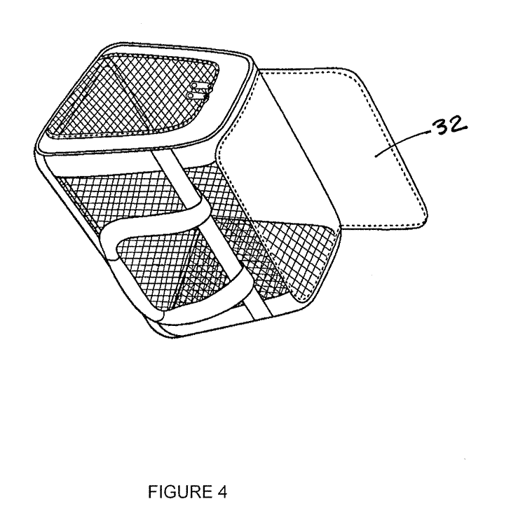

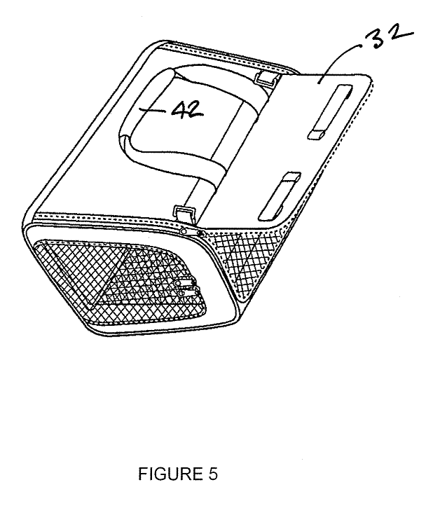

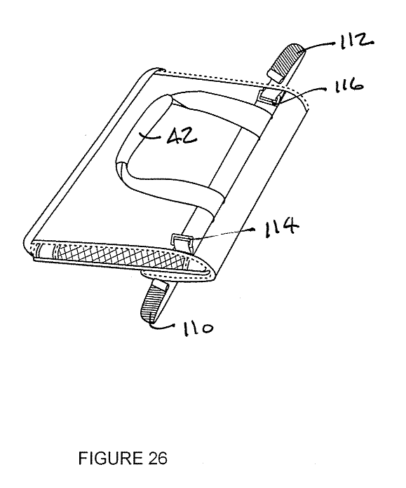

Referring to the figures, the foldable pet cage construction depicted is generally comprised of flexible fabric materials such as cloth, canvas, various synthetic fabrics and the like. In a preferred embodiment, the pet cage construction includes a front side panel 30, a top side panel 32, a bottom side panel 34, a back side panel 36, a first end panel 38 and an opposite or second end panel 40. In the preferred embodiment, each of the panels 30, 32, 34, 36 and 38 is generally four-sided. The four sides are not necessarily each rectangular though they may be rectangular. For example, the front side panel 30, top side panel 32, bottom side panel 34 and back side panel 36 may be generally rectangular whereas the first and second end panels 38 and 40 may be generally trapezoidal in shape. The six panels comprising the enclosure, however, are joined together by various means such as by stitching or by means of fastening elements to provide an enclosure in which a pet may be housed, for example, as depicted in FIG. 1. In a preferred embodiment, the assembled and opened pet cage includes a first flexible handle 42 attached to the back side panel 36 and a second optional flexible handle 44 attached to the front side panel 30. The handles 42 and 44 are preferably formed from a fabric material and may include a grip, such as grip 46 to facilitate comfort when lifting the cage or enclosure. Thus, a grip 46 and a grip 48 associated, respectively, with the handles 42 and 44 may be centered on the handles 42 and 44, respectively. The grips 46 and 48 may include hook and loop fastening material to enable attachment of the handles 42 and 44 to one another. Also first handle 42 may be available to carry the cage in the folded configuration as in FIG. 26.

Associated with or incorporated with the enclosure is an auxiliary bottom side panel 50. The auxiliary bottom side panel 50 is foldable about a lateral side edge 52 where it is attached, for example, by stitching, to the lower end of the back side panel 36 where it intersects the bottom side panel 34. The auxiliary bottom side panel 50 may thus pivot or be turned about the edge 52. Typically, the auxiliary bottom side panel 50 is congruent with the bottom panel 34. The bottom panel 34 is typically fabricated from a fabric material. The auxiliary bottom side panel 50 is also typically fabricated from a fabric material. The bottom panel 50 may also include a polyethylene sheet, for example, which provides some stiffness to the bottom side panel 50 and thus tends to preserve its shape or configuration. The auxiliary bottom side panel 50 includes a tab 54 which may be gripped to facilitate pivoting of the auxiliary bottom side panel 50 about its lateral side 52.

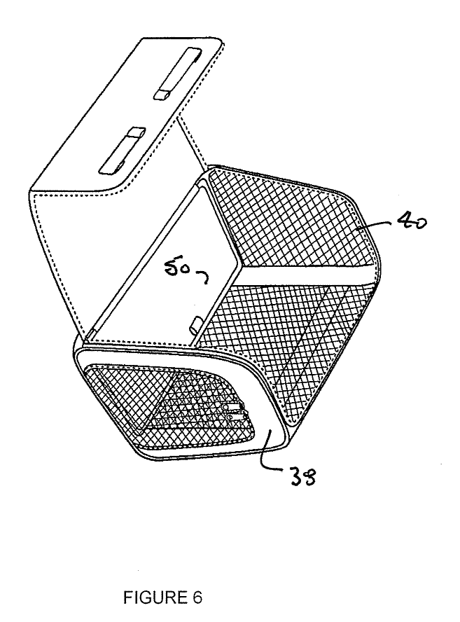

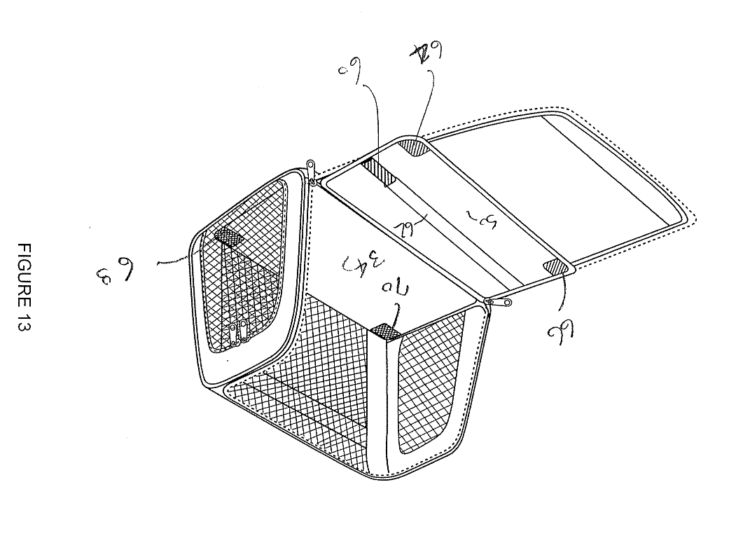

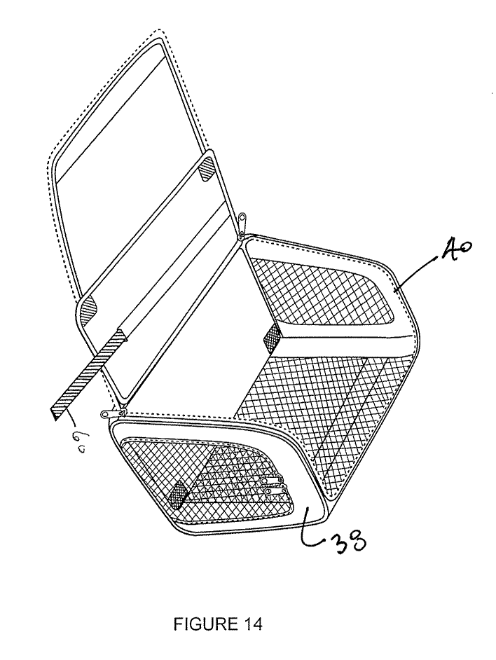

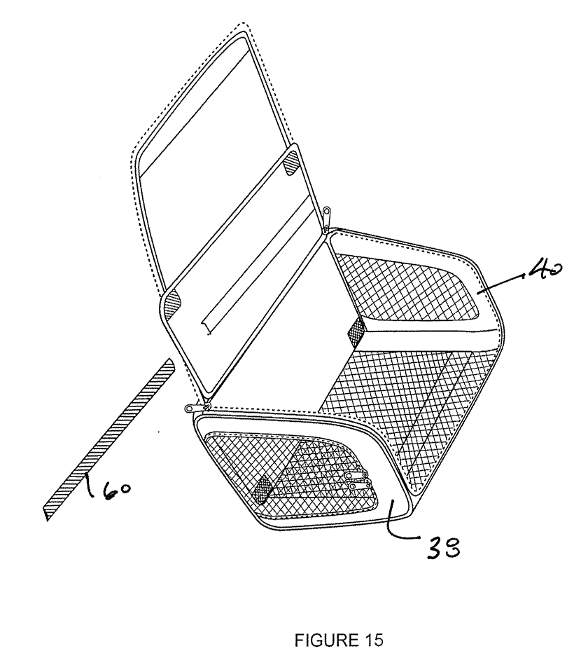

In a preferred embodiment, the auxiliary bottom side panel includes a reinforcing element such as reinforcing element 60 as shown in FIG. 13. The reinforcing element 60 may comprise a bamboo wand or strip which can be sewn into the underside of the auxiliary bottom side panel 50 and held in place by means of a band 62. Alternatively, the band 62 may form a receiving tube for placement of the reinforcing element 60 therein. Further, the auxiliary bottom side panel 50 may include a hook and loop fastening element such as hook and loop fastening elements 64 and 66 which cooperate with hook and loop fastening elements 68 and 70 positioned at corners of the inside surface of the bottom side panel 34 as depicted in FIG. 13 so that the auxiliary bottom side panel 50 can be held in position, for example, as depicted in FIG. 6.

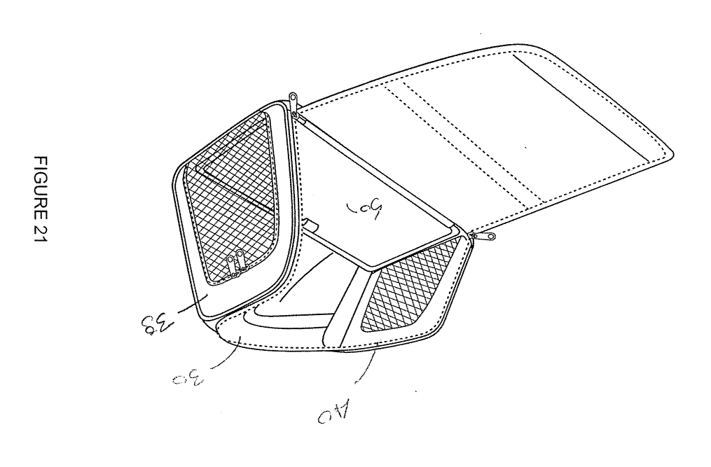

The first and second end panels 38 and 40 are joined along their bottom edges to the opposite sides of the bottom panel 34. The first and second end panels 38 and 40 are generally congruent in shape. As depicted in FIGS. 16-20 the end panels 38 and 40 typically include a peripheral margin 80 extending along the lateral side edges and top edges of the panel. The margin 80 forms a boundary for an interior mesh panel, such as mesh panel 82 associated with the first end panel 38 and mesh panel 84 associated with the second end panel 40. The mesh panel 82 is provided with a partially peripheral zipper 86 along the lateral and top sides of the panel 82. Thus, the zipper 86 may be operated to open the panel 82 so that it will fold about the lower edge 88 thereof as depicted in FIG. 1 to permit access to the enclosure. The mesh panel 84 on the second end panel 40 may or may not include a zipper arrangement.

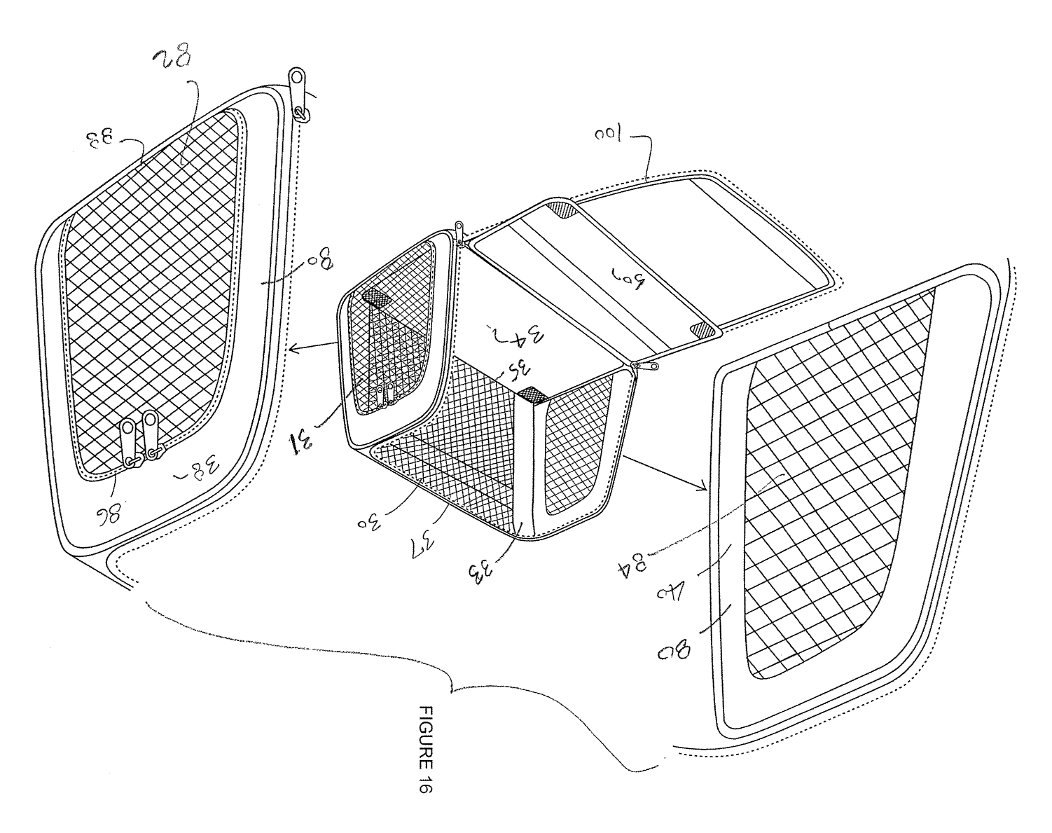

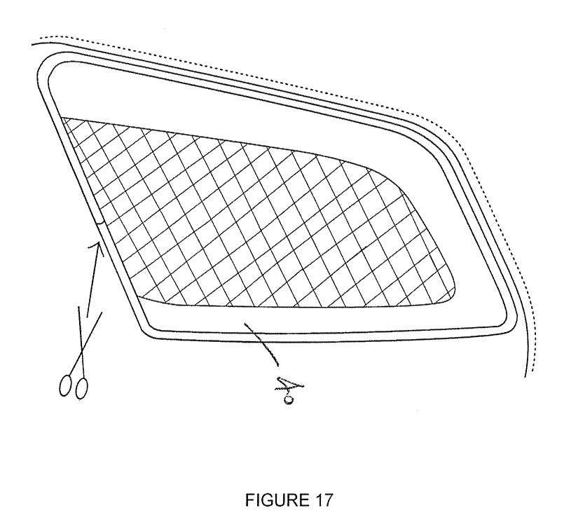

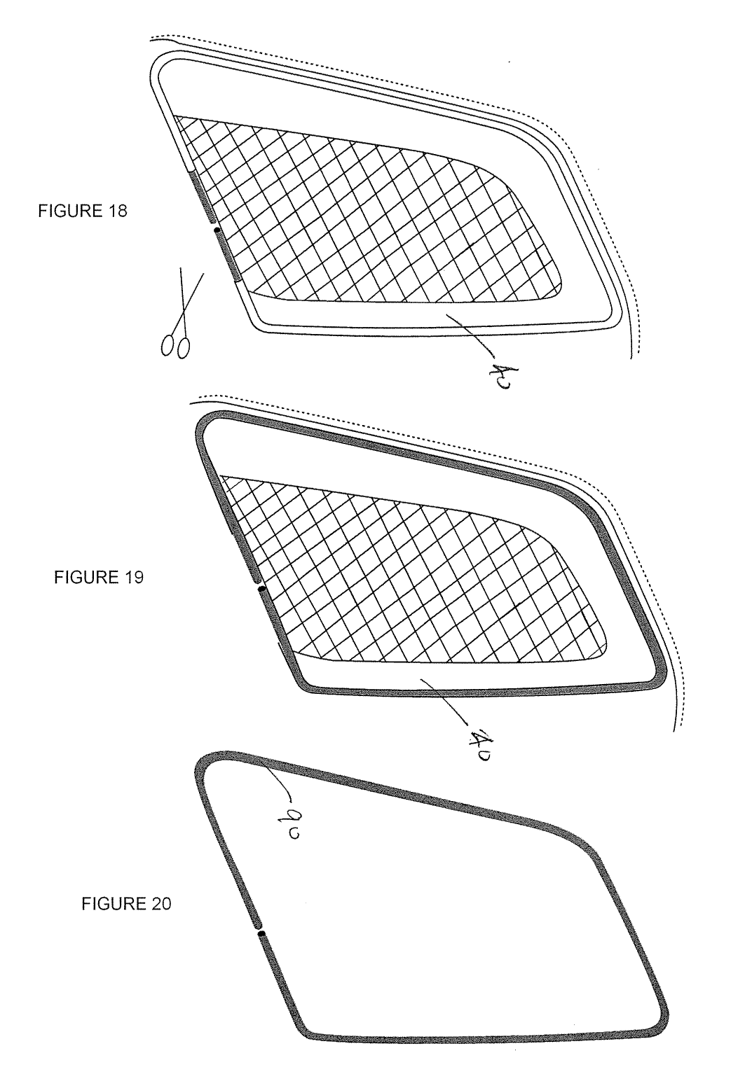

The end panels 38 and 40 are each of similar construction. That is, as depicted in FIGS. 17-20, the periphery thereof includes a reinforcing element; namely, a peripheral wire rod 90 which forms an outline of each of the end panels 38 and 40. The peripheral wire rod 90 is, in a preferred embodiment, sewn into the end panels 38 and 40 to provide reinforcement for the end panels 38 and 40. Note that FIGS. 18-20 illustrate the end panel 40. The peripheral rod or reinforcing element 90 maintains the shape and configuration of the end panels 38 and 40. Other types of reinforcing elements other than a metal rod may be utilized to provide the reinforcing feature considered desirable with respect to the embodiment of the invention.

Each of the end panels 38, 40, as previously mentioned, is attached, for example, by stitching to the lateral side edges of the bottom panel 50. The front panel 30 is preferably fabricated from a flexible mesh material again to permit ventilation and light to flow into the formed enclosure. The lateral sides of the front side panel 30, that is, the sides 31 and 33 define margins which are attached to the end panels 38 and 40, respectively. The front panel 30 is joined along its bottom edge to the front side of the bottom panel 34; namely, the front side 35. Thus, the end panels 38 and 40 in combination with the front panel 30 and bottom side panel 34 form a portion of an enclosure comprised of the four described side panels which are attached or affixed one to the other. To complete the enclosure, of course, the auxiliary bottom side panel 50 may be placed over the bottom side panel 34. The back side panel 36 and top side panel 32 may then be folded over and attached respectively to the end panels 38 and 40 along a lateral and top side edge and to the top side 37 of the front side panel 30. The connection of the back side panel 36 and top side panel 32 is effected by means of a zipper mechanism 100. However, other mechanisms may be utilized to effect the attachment or detachment thereof, such as clips or a hook and loop arrangement.

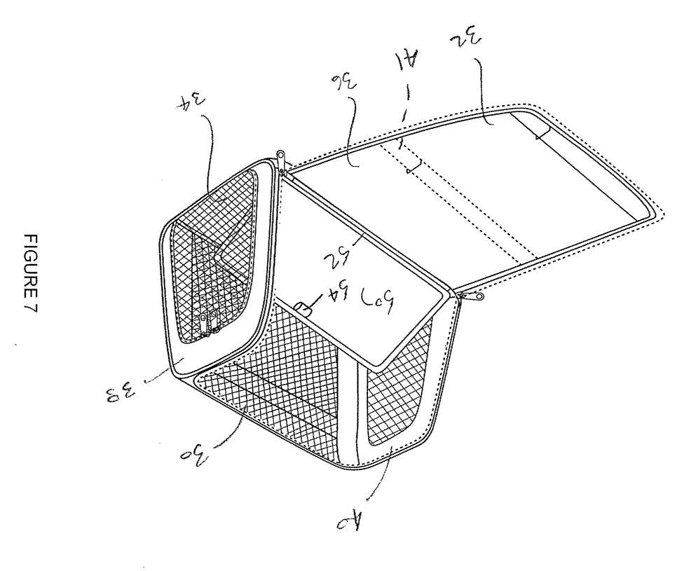

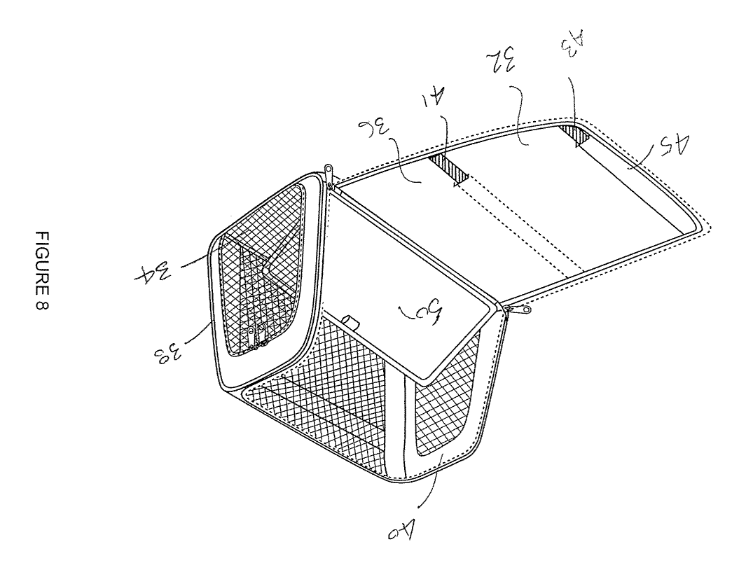

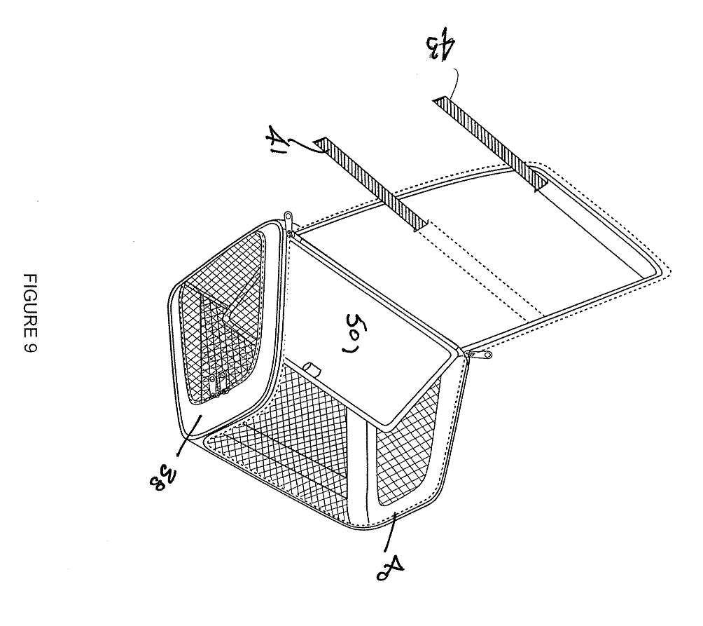

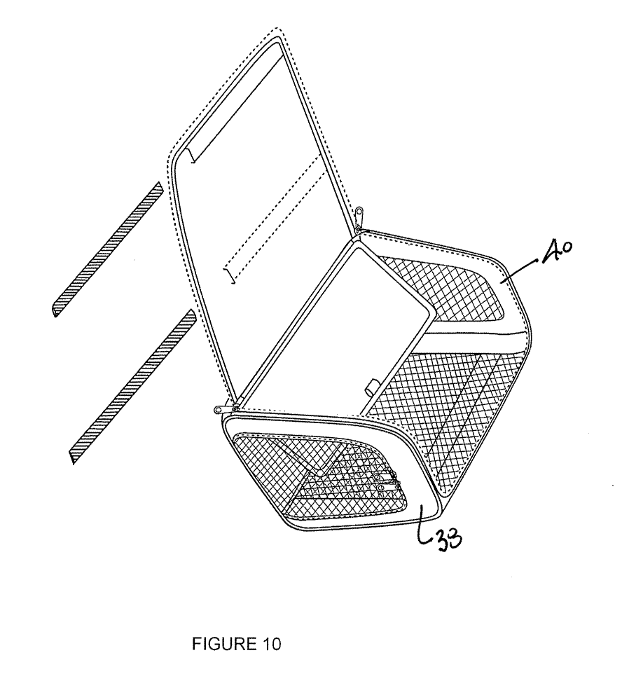

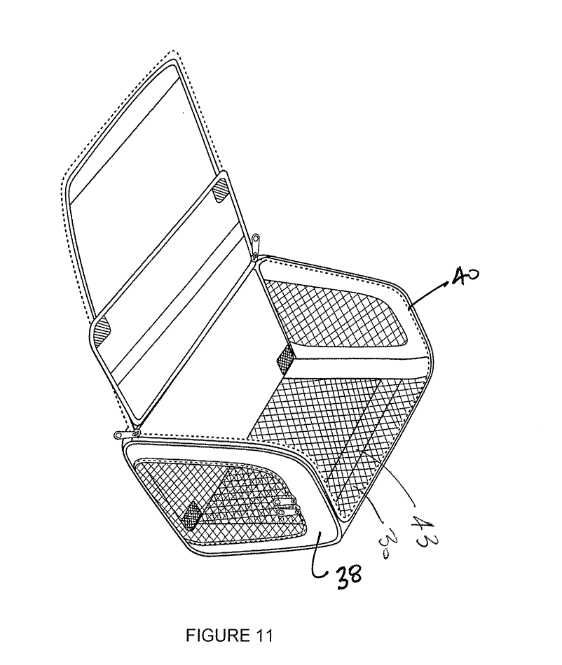

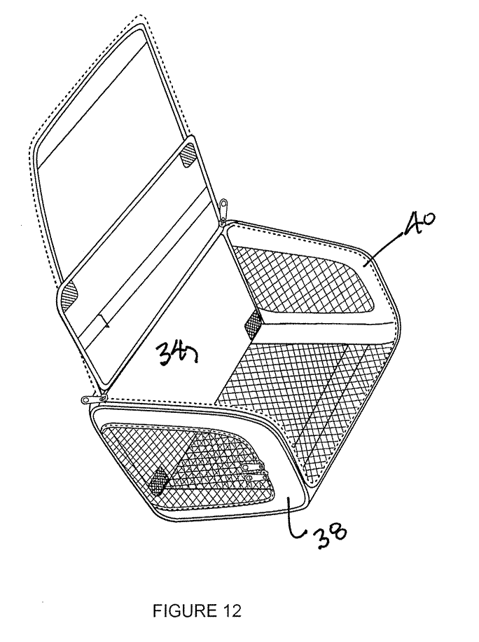

Referring to FIGS. 7-10, the back side panel 36 includes a reinforcing element 41 generally adjacent or at a top side margin of the back side panel 36. The reinforcing element 41 in FIG. 8 may be sewn into the back side panel 36 or may be inserted into a pocket defined within or otherwise provided for the back side panel 36. Preferably, the position of the reinforcing element 41 is symmetric with a support band 43 for the handle 44 associated with the front side panel 30. This symmetrical arrangement promotes balance when carrying the pet cage by handles 42, 44. The purpose of the reinforcing element 41 is to provide rigidity between the end panels 38 and 40 and above the plane of the bottom side panel 34. The utilization of the reinforcing element 41 as well as the peripheral reinforcing elements, associated with the end panels 38 and 40; namely, the peripheral elements 90, in combination with the reinforcing elements or shape holding elements associated with the bottom panel 34 and auxiliary bottom panel 50 provide a pet cage, which when assembled, maintains its desired shape and thus forms a comfortable and open enclosure for a pet, such as depicted in FIG. 1.

As an optional extra feature, a further reinforcing element 43 may be included along the top margin 45 of the top side panel 32 as depicted in FIG. 8, for example. The reinforcing element 43 again may be sewn into the top side panel 32 or it may be inserted into an opening or slot which is provided therein. The use of the additional reinforcing element 43 provides yet another means for insuring that the integrity of the formed enclosure will be maintained when the pet cage is in the configuration depicted, for example, in FIG. 1.

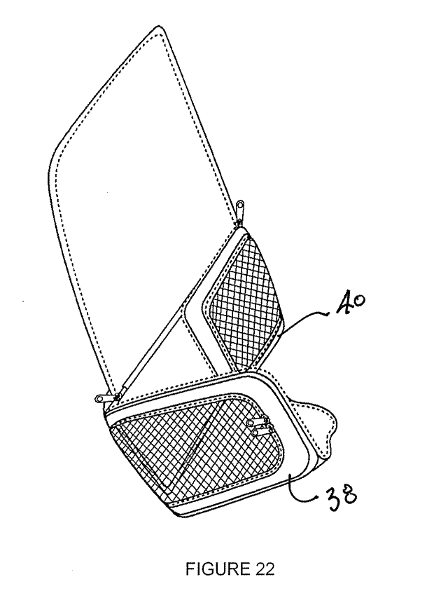

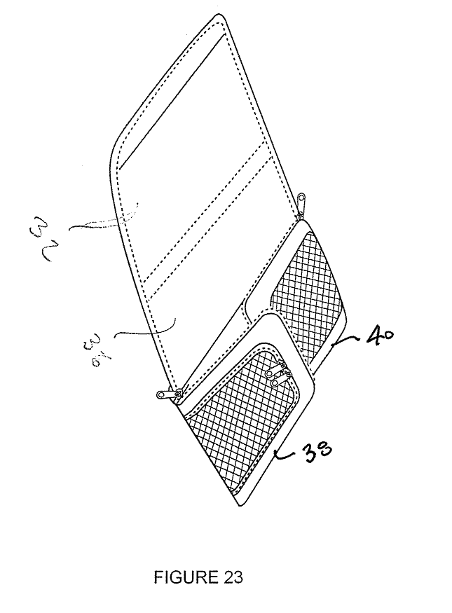

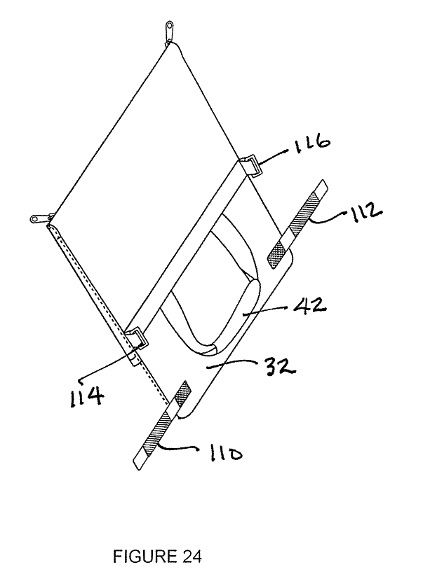

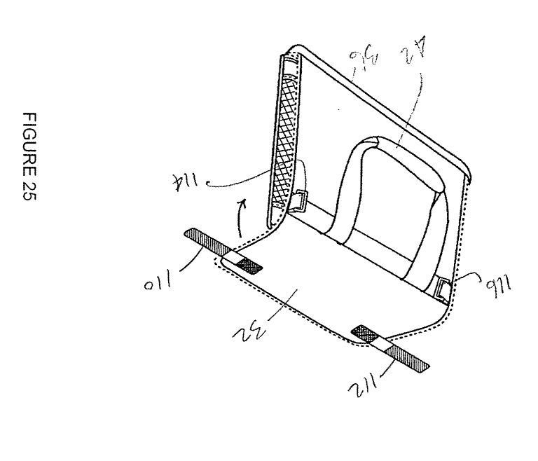

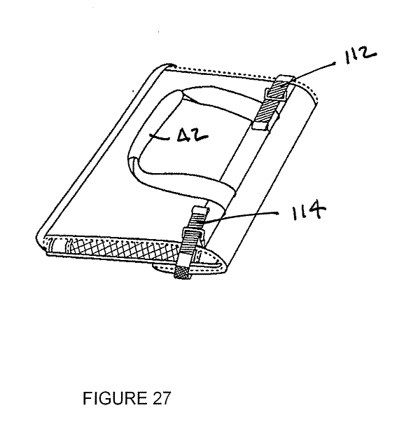

Beginning with FIG. 21 there is illustrated the manner in which the pet cage construction is folded. Since the front side panel 30 is flexible, the front side panel 30 may be folded in combination with the generally rigid end panels 38 and 40 over the bottom panel 34 and the auxiliary bottom panel 50 as depicted in FIG. 21. Sequentially in the folding operation, the end panels 38 and 40 are folded as depicted in FIGS. 22 and 23 so that they are positioned flat over the front side panel 30 and bottom panel 34 and auxiliary bottom panel 50. Sequentially in the folding operation each end panel 38 and 40 will individually fold in. The first end panel 40 will fold to lay flat over the bottom panel 50 creating a triangular fold in front panel 30. Front panel 30 is then folded triangularly again to fit on top of the first end panel 40 and the secsond end panel 38 will fold in and lay flat on top of folded front panel 30 and the first end panel 40. The back side panel 36 may then be folded over the configuration depicted in FIG. 23. Thus, as depicted in FIG. 23, the back side panel 36 fits over the end panels 38 and 40 and the top side panel 32 will then fold, at least partially, over the front side panel 30 as depicted, for example, in FIGS. 24-29. Note that the handle 42 associated with the back side panel 36 will remain accessible during this folding sequence so that the final folded container or pet cage can be easily carried.

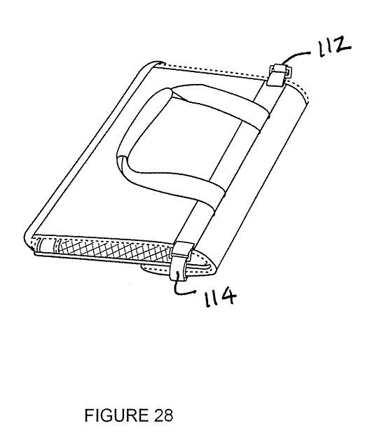

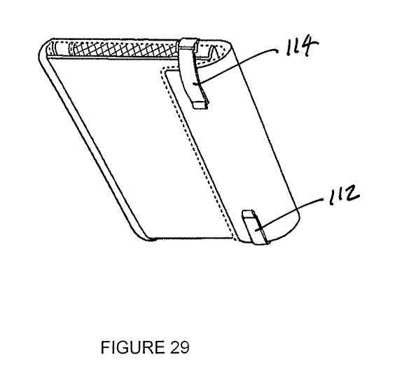

Thereby, a preferred feature of the invention is the inclusion of fastening straps 110 and 112 which are incorporated on the outer side of the top side panel 32 and which fit through buckles 114 and 116, respectively, on the back side panel 36 as depicted, for example, in FIGS. 25-29. In this manner, as depicted, for example, in FIGS. 28 and 29 a compact, folded pet cage assembly is maintained for ease of storage, for packaging or the like.

Thus, with the construction of the embodiment so described, a foldable pet cage may be folded from the condition depicted in FIG. 29 to the condition depicted in FIG. 1 and vice versa. The assembly is thus totally collapsible.

Variations of the construction may be effected without departing from the spirit and scope of the invention. For example, the bottom side panel 34 may incorporate a reinforcing element and the auxiliary bottom panel 50 may be omitted or it may be sewn into place against the bottom side panel 34. Additionally, the bottom side panel 34 may itself be fabricated from a partially rigid or semi-rigid material which would not require reinforcing elements inasmuch as it would be adequately stiff to provide rigidity and spacing between the end panels 38 and 40. Thus, the invention is to be limited only by the following claims and equivalents thereof.

What is claimed is:

1. A foldable pet cage comprising, in combination:
a collapsible, generally six, four-sided panel enclosure of generally flexible material reinforced with stiffening elements incorporated in selected panels, said panels including:
a back side panel;
a front side panel;
a first end panel with a generally peripheral first stiffening element,
a second end panel spaced from, generally parallel to and substantially congruent in size to the first end panel, said second end panel including a generally peripheral second stiffening element;
said first end panel and said second end panel each including a bottom, first and second lateral sides and a top side;
a bottom panel joining the bottom sides of the first and second end panels, said bottom panel including first and second sides comprising, respectively, an intersection boundary for said back side panel and an intersection boundary for said front side panel;
said front side panel joining the first lateral sides of the first and second end panels,
said back side panel attachable to the second lateral sides of the first and second end panels to form an enclosure with a top opening, said back side panel including a top side margin with a stiffening element extending intermediate the first and second end panels;
a top side panel joined to the top side of the back side panel and foldable over the top of the enclosure; and
a fastening element for detachable joinder of the back side panel and top side panel to the first and second end panels and joinder of the top side panel to the top of the front side panel to complete the enclosure, whereby the top side panel and back side panel may be detached from the front side panel and end panels, and said end panels and front panel may be folded over the bottom panel whereupon the back side panel and top side panel may be wrapped over the folded end side panels, front side panel and bottom side panel to form a compact of the panels overlying each other.

2. The cage of claim 1 wherein one of the end panels includes a partially detachable flap forming the said end panel.

3. The cage of claim 1 further wherein said stiffening element incorporated in the back side panel extends substantially entirely between the lateral sides of the back side panel.

4. The cage of claim 1 further including a first handle attached to the back side panel.

5. The cage of claim 3 further including a first handle attached to the back side panel.

6. The cage of claim 5 wherein the first handle is attached at the stiffening element.

7. The cage of claim 4 including a second handle attached to the front side panel.

8. The cage of claim 1 further including an auxiliary bottom side panel within the enclosure and generally congruent with the bottom side panel, said auxiliary bottom side panel foldable about the intersecting boundary of the back side panel and bottom side panel, said auxiliary bottom side panel comprised a shape maintaining element for maintaining the generally rectangular configuration of the bottom panel.

9. The cage of claim 8 wherein the auxiliary bottom panel shape maintaining element comprises a shape retaining sheet.

10. The cage of claim 9 wherein the sheet includes a generally smooth top side and a bottom side with reinforcing members.

11. The cage of claim 3 further including a first handle attached to the stiffening element and a second handle attached to the front side panel, said first and second handles arranged symmetrically on the back side panel and front side panel, respectively.

12. The cage of claim 1 wherein the top side panel and back side panel fastening element is a continuous zipper mechanism.

13. The cage of claim 1 further including at least one retention strap for holding the folded panels in the closed configuration.

14. The cage of claim 13 wherein the back side panel and top side panel have an outside face, and said top side panel is folded over the bottom side panel and the back side panel is folded over the end panels in the closed cage configuration, said retention strap attachable between the outside face of the top side panel and top side of the back side panel to retain the cage in the closed configuration.

15. The cage of claim 1 wherein at least portions of one or more of the end panels and front panel comprise a fabric mesh.
